(19) United States
(12) Patent Application Publication
(10) Pub. No.: US 2012/0230537 A1
(43) Pub. Date: Sep. 13, 2012

(54) TAG INFORMATION MANAGEMENT APPARATUS, TAG INFORMATION MANAGEMENT SYSTEM, NON-TRANSITORY COMPUTER READABLE MEDIUM, AND TAG INFORMATION MANAGEMENT METHOD

(75) Inventors: Kenji Takahashi, Nagoya-shi (JP); Hayato Kato, Nagoya-shi (JP); Hiroaki Kawasaki, Nagoya-shi (JP); Yutaka Maruyama, Nagoya-shi (JP)

(73) Assignee: Buffalo Inc., Nagoya-shi (JP)

(21) Appl. No.: 13/293,855

(22) Filed: Nov. 10, 2011

(30) Foreign Application Priority Data
Nov. 11, 2010 (JP) 2010-252918

(51) Int. Cl. G06F 17/30; G06K 9/62

(52) U.S. Cl. 382/103; 707/755; 707/E17.009

(57) ABSTRACT

A tag data management apparatus for managing tag data indicative of an attribute of content data, comprising: an extraction section that extracts positional information included in the content data, the positional information being indicative of a position associated with the content data; and a priority order determination section that determines a priority order of the content data, based on the positional information extracted by the extraction section.

### CROSS REFERENCE TO RELATED APPLICATIONS

This application is based upon and claims the benefit of priority from prior Japanese Patent Application No. 2010-252918, filed on Nov. 11, 2010; the entire content of which is incorporated herein by reference.

### BACKGROUND OF THE DISCLOSURE

1. Technical Field

This disclosure relates to a tag data management apparatus, a tag data management system, a non-transitory computer readable medium, and a tag data management method, for managing information related to tag indicative of indicative of an attribute of data.

2. Description of the Related Art

In recent years, since prices of recording mediums are getting lower and capacities of recording mediums are getting larger, users hold a large amount of data (hereinafter, called as contents data) formed of contents such as image data, voice data, or document data. Thus, appropriate management of a large amount of content data is required.

For example, the Description of JP-A-2004-312244 discloses a method of collectively recording acquired image indicating a same attribute in one recording folder, which facilitates management of the acquired image.

Incidentally, as content data, there coexist content data that is important for a user and content data that is not important. Thus, appropriate prioritization according to degree of importance is required as to content data.

### SUMMARY

A feature of this disclosure is summarized as tag data management apparatus (set top box 10) for managing tag data indicative of an attribute of content data, comprising: an extraction section (tag data extraction section 154) that extracts positional information (geo tag data) included in the content data, the positional information being indicative of a position associated with the content data; and a priority order determination section (priority order determination section 156) that determines a priority order of the content data, based on the positional information extracted by the extraction section.

Such a tag data management apparatus determines a priority order of the content data, based on the positional information that is tag data assigned to the content data. In a case where a degree of importance of content data depends on a geographic position, appropriate prioritization can be performed by determining the priority order of the content data based on the positional information.

The feature of the present disclosure is summarized as that the priority order determination section determines the priority order based on each of a plurality of predetermined geographic areas.

The feature of the present disclosure is summarized as that the extraction section extracts time information (time tag data) attached to the content data, the time information being indicative of a time associated with the content data, and the priority order determination section determines a priority order of the content data, based on the time information extracted by the extraction section.

The feature of the present disclosure is summarized as that the priority order determination section determines the priority order of the content data in accordance with at least either one of: the number of content data having a position included in the predetermined geographic area; and the number of persons who generate the content data having a position included in the predetermined geographic area.

The feature of the present disclosure is summarized as that the content data is image data, and the priority order determination section determines the priority order of the content data, in accordance with a result of image recognition using the image data.

The feature of the present disclosure is summarized as that a result of the image recognition is at least either one of the number of objects and a facial expression of the objects.

The feature of the present disclosure is summarized as the tag data management apparatus comprising a first display processing section (display processing section 158) that displays an image indicative of the priority order of the content data having the positional information, for each of the plurality of the predetermined geographic areas.

The feature of the present disclosure is summarized as the tag data management apparatus comprising a second display processing section (display processing section 158) that displays an image indicative the priority order of the content data having the positional information at different time, for each of the plurality of the predetermined geographic areas.

A feature of the present disclosure is summarized as a tag data management system for managing tag data indicative of an attribute of content data, comprising: an extraction section that extracts positional information included in the content data, the positional information being indicative of a position associated with the content data; and a priority order determination section that determines a priority order of the content data, based on the positional information extracted by the extraction section.

A feature of the present disclosure is summarized as a non-transitory computer readable medium including a computer program cause a computer to manage tag data indicative of an attribute of content data, the computer program cause the computer to perform a method comprising the steps of: extracting positional information included in the content data, the positional information being indicative of a position associated with the content data; and determining a priority order of the content data, based on the extracted positional information.

A feature of the present disclosure is summarized as a tag data management method used in a tag data management system for managing tag data indicative of an attribute of content data, comprising the steps of: extracting positional information included in the content data, the positional information being indicative of a position associated with the content data; and determining a priority order of the content data, based on the extracted positional information.

### BRIEF DESCRIPTION OF THE DRAWINGS

FIG. 1 is a structural view of a set top box according to an embodiment of the present disclosure.

FIG. 2 is a view showing a structure of image data used in the embodiment shown in FIG. 1.

FIG. 3 is a view showing one example of geographic area information used in the embodiment shown in FIG. 1.

FIG. 4 is a view showing one example of a map image indicative of prioritization of content data having a position included in different geographic area unit at different time.

FIG. 5 is a view showing one example of a map image indicative of a time transition of the prioritization of the content data for each geographic area units.

FIG. 6 is a view showing another example of a map image showing the prioritization of the content data for each geographic area units.

FIG. 7 is a flowchart showing an operation of the set top box shown in FIG. 1.

FIG. 8 is an entire schematic structural view of a content management system according to another embodiment of the present disclosure.

### DETAILED DESCRIPTION

Next, the embodiments of the present disclosure will be described with reference to the drawings, in an order of (1) structure of a set top box, (2) operation of the set top box, (3) operations and advantageous effects of the set top box, and (4) other embodiments. Throughout all figures, the same or similar constituent elements are designated by the same or similar reference numerals.

### (1) Structure of Set Top Box

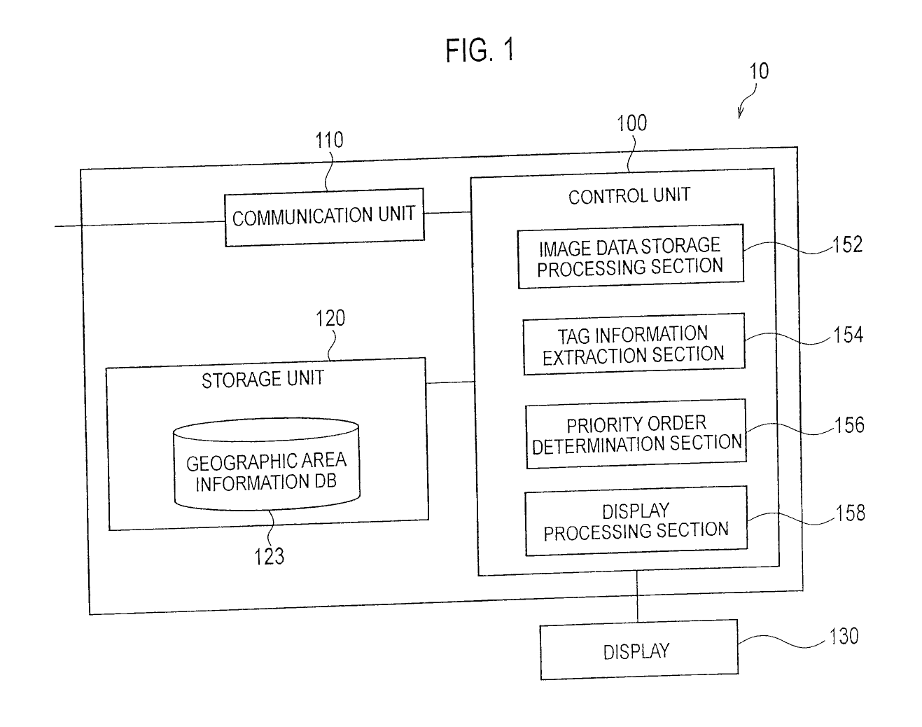

FIG. 1 is a structural view of a set top box 10 as a content management apparatus. The set top box 10 shown in FIG. 1 manages image data that is transmitted from a digital camera that is an external device, although not shown. The set top box 10 mainly includes a control unit 100, a communication unit 110, a storage unit 120, and a display 130.

The control unit 100 includes a CPU, for example, and controls a variety of operations included in the set top box 10.

The communication unit 110 is a LAN card, for example, and a MAC (Media Access Control) address is assigned to the LAN card. The communication unit 110 is a communication interface that makes communication with an external device, and makes communication with an external communication apparatus via a communication network. The storage unit 120 is a NAND flash memory, for example, and stores a variety of information employed for control or the like in the set top box 10. The display 130 displays a variety of images in accordance with an instruction from the control unit 100.

The control unit 100 mainly includes an image data storage processing section 152, a tag data extraction section 154, a priority order determination section 156, and a display processing section 158.

The image data storage processing section 152 receives via the communication unit 110 image data as content data that is transmitted from a digital camera. Further the image data storage processing section 152 causes a storage unit 120 to store the received image data.

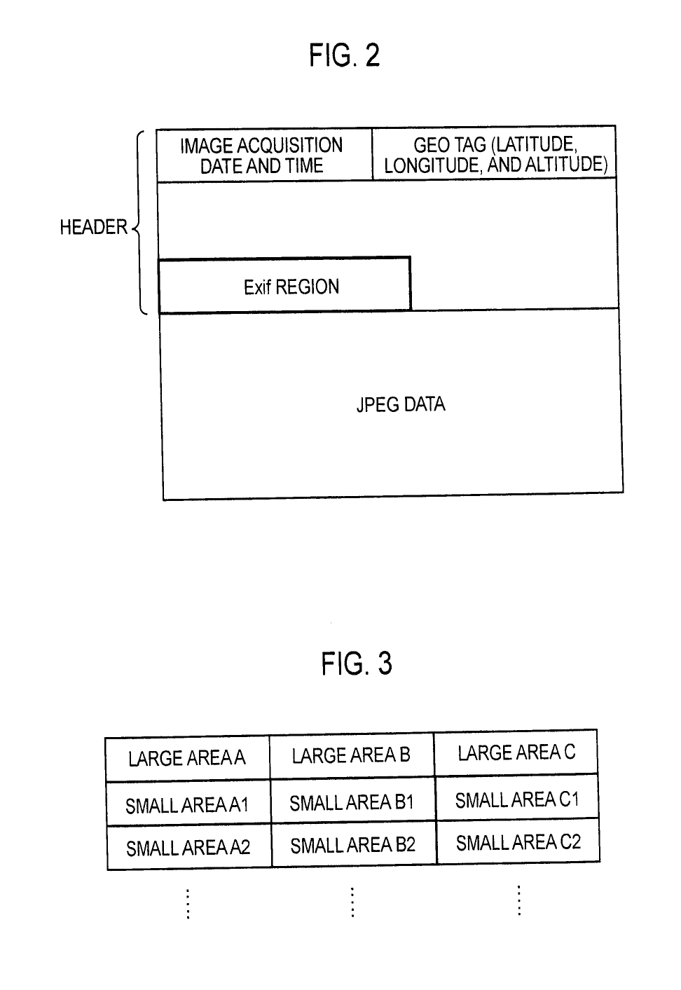

FIG. 2 is a view showing a structure of image data. The image data shown in FIG. 2 is formed of a header and JPEG (Joint Photographic Experts Group) data.

The header includes tag data indicative of an attribute of image data. The tag data is information indicative of the attribute of image data, the information being assigned at the time of image acquisition by means of a digital camera. The tag data is time information indicative of image acquisition date and time (time tag data) and positional information indicative of a latitude, a longitude, and an altitude of an image acquisition position (geo tag data. In addition, the header includes an Exif (Exchangeable image file format) region. The Exif region includes an user information (user ID) that is photographer identification information.

A description will be given with turning to FIG. 1 again. The tag data extraction section 154 extracts geo tag data, time tag data, and a user ID from the image data that is stored in the storage unit 120.

The tag data extraction section 154 may extracts the positional information, the time tag data, or the user information inputted by a user, if the geo tag data, the time tag data, or the user ID are not included in the image data.

The priority order determination section 156 reads out each of the image data from the storage region 120. The priority order determination section 156 performs image recognition processing, based on the read out image data. The image recognition processing used herein is recognition of the number of objects, recognition of a facial expression of an object, recognition of a color in an image, and detection of a straight line in an image or the like.

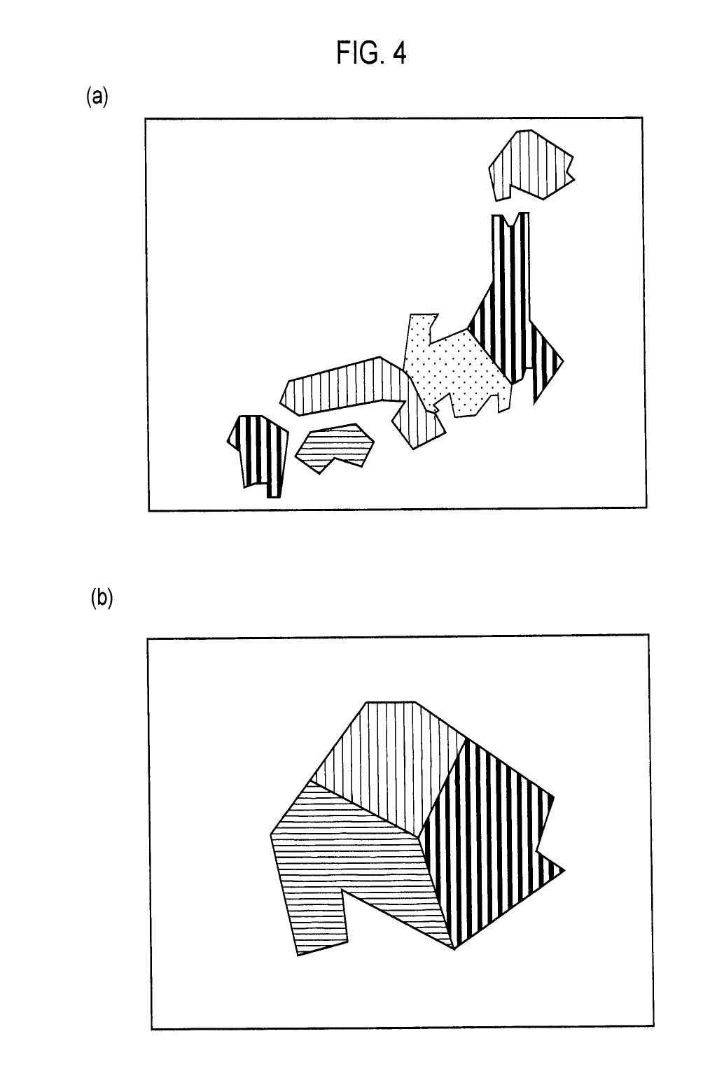

In addition, the priority order determination section 156 reads out geographic area information from the storage unit 120. FIG. 3 is a view showing one example of the geographic area information. The geographic area information is information on a hierarchical structure, which is formed of geographic information on a large area and geographic information on a small area included in the large area. Each of the large geographic area information is formed of a set of information on a latitude and a longitude of an outer edge defining the large area. Each of the small geographic area information is formed of a set of information on a latitude and a longitude of an outer edge defining the small area.

Next, the priority order determination section 156 determines a priority order of image data in a unit of large area or small area, based on extracted geo tag data, extracted time tag data and extracted user ID, a result of image recognition, and geographic area information, according to following operation.

Here, the prioritization based on the large area or the prioritization based on the small area may be selected by an user. Alternately, the prioritization result based on the large area may be added to the prioritization result based on the small area, or the prioritization result based on the small area may be added to the prioritization result based on the large area.

### (First Processing Operation)

The priority order determination section 156 determines a latitude and a longitude of geo tag data belong to which of a large area and a small area, based on the latitude and the longitude of the geo tag data extracted from each of image data, a set of the latitude and the longitude of an outer edge in the large area, and a set of the latitude and the longitude of an outer edge in the small area.

Next, the priority order determination section 156, in each large area, computes the number of image data having the geo tag data including the latitude and the longitude that belong to the large area, and performs prioritization of the image data based on the computed number. Specifically, the priority order determination section 156 performs prioritization of the image data so as to set the higher priority order to the image data belongs to the large area, as the number of the image data having the geo tag data including the latitude and the longitude that belong to the large area is larger.

Similarly, the priority order determination section 156, in each small area, computes the number of image data having the geo tag data including the latitude and the longitude that belong to the small area, and performs prioritization of the image data having the geo tag data including the latitude and the longitude that belong to the small area. Specifically, the priority order determination section 156 performs prioritization of the image data so as to set the higher priority order to the image data belongs to the small area, as the number of the image data having the geo tag data including the latitude and the longitude that belong to the small area is larger.

The priority order determination section 156 may perform the above-described processing operation by using another item of image data that is acquired from the Internet or the like as well as the image data stored in the storage unit 120.

### (Second Processing Operation)

The priority order determination section 156 determines a latitude and a longitude of geo tag data belongs to which of a large area and a small area, based on a latitude and a longitude of the geo tag data extracted from each of image data, a set of a latitude and a longitude of an outer edge in the large area, and a set of a latitude and a longitude of an outer edge in the small area.

Next, the priority order determination section 156, in each large area, selects the image data having the geo tag data including the latitude and longitude that belong to the large area, computes the number of types of user IDs included in the specified image data, and performs the prioritization of the image data based on the computed result. Specifically, the rang determination section 156 performs the prioritization of image data so as to set the higher priority order to the image data having the geo tag data including the latitude and the longitude that belong to the large area, as the computed number of types of user IDs is larger.

Similarly, the priority order determination section 156, in each small area, selects the image data having the geo tag data including the latitude and longitude that belong to the small area, computes the number of types of user IDs included in the specified image data, and performs the prioritization of the image data based on the computed result. Specifically, the rang determination section 156 performs the prioritization of image data so as to set the higher priority order to the image data having the geo tag data including the latitude and the longitude that belong to the small area, as the computed number of types of user IDs is larger.

### (Third Processing Operation)

The priority order determination section 156 determines a latitude and a longitude of geo tag data belongs to which of a large area and a small area, based on a latitude and a longitude of the geo tag data extracted from each of image data, a set of a latitude and a longitude of an outer edge in the large area, and a set of a latitude and a longitude of an outer edge in the small area.

In addition, the priority order determination section 156 determines which of time intervals a date and time of time tag data belongs to, based on a date and time of the geo tag data extracted from each of image data and a predetermined time interval.

Next, the priority order determination section 156, in each large area and at each time intervals, computes the number of image data having the geo tag data including the latitude and the longitude that belong to the large area and the time tag data including the date and time that belong to the time interval, and performs the prioritization of the image data based on the computed result. Specifically, the priority order determination section 156 performs prioritization of image data so as to set the higher priority data to the image data, as a larger number of the image data having go tag data including the latitude and the longitude that belong to the large area and the time tag data including the date and time that belong to the time interval.

Similarly, the priority order determination section 156, in each small area and at each time intervals, computes the number of image data having the geo tag data including the latitude and the longitude that belong to the small area, and the time tag data including the date and time that belong to the time interval, and performs the prioritization of the image data based on the computed result. Specifically, the priority order determination section 156 performs the prioritization of image data so as to set the higher priority order to the image data, as a larger number of the image data having go tag data including the latitude and the longitude that belong to the large area and the time tag data including the date and time that belong to the time interval.

The priority order determination section 156 may perform the above-described processing operation by using another item of image data that is acquired from the Internet or the like as well as the image data that is stored in the storage unit 120.

### (Fourth Processing Operation)

The priority order determination section 156 determines a latitude and a longitude of geo tag data belongs to which of a large area and a small area, based on a latitude and a longitude of the geo tag data extracted from each of image data, a set of a latitude and a longitude of an outer edge in the large area, and a set of a latitude and a longitude of an outer edge in the small area.

Next, the priority order determination section 156, in each large area, computes a color rate and then computes an average value of color rates for each of image data, based on a recognition result of a color in an image, as to image data having the geo tag data including the latitude and the longitude that belong to the large area. Herein, for example, there appears a tendency that in a case where a large area is a forest area, a rate of green that is a color of a forest is higher, or alternatively, in a case where a large area is a beach side, a rate of blue that is a color of sea is higher, for example.

Next, the priority order determination section 156, in each large area, performs the prioritization of image data having the geo tag data including the latitude and the longitude that belong to the large area. Specifically, the priority order determination section 156 performs the prioritization of image data so as to set the higher priority order to the image data having the geo tag data including the latitude and the longitude that belong to the large area, as the average value in rate of a predetermined color is higher.

Similarly, the priority order determination section 156, in each small area, computes a color rate and then computes the average value in rate of the color, based on a recognition result of a color in an image, as to the image data having the geo tag data including the latitude and the longitude that belong to the small area.

Next, the priority order determination section 156, in each small area, performs the prioritization of image data having the geo tag data including the latitude and the longitude that belong to the small area. Specifically, the priority order determination section 156 perform the prioritization of image data so as to set the higher priority order to the image data having the geo tag data including the latitude and the longitude that belong to the small area, as the summing result of the rate of a predetermined color is higher.

### (Fifth Processing Operation)

The priority order determination section 156 determines a latitude and a longitude of geo tag data belongs to which of a large area and a small area, based on a latitude and a longitude of the geo tag data extracted from each of image data, a set of a latitude and a longitude of an outer edge in the large area, and a set of a latitude and a longitude of an outer edge in the small area.

Next, the priority order determination section 156, in each large area, acquires the number of straight lines in an image and then computes a value indicating a total number of straight lines for each of image data, as to image data having the geo tag data including the latitude and the longitude that belong to the large area. Herein, for example, there appears a tendency that in a case where a large area is a new urban area, the number of straight lines increases, or alternatively, in a case where a large area is an old urban area, the number of straight lines decreases.

Next, the priority order determination section 156 performs the prioritization of image data so as to set the higher priority order to the image data having the geo tag data including the latitude and the longitude that belong to each large area, as a value indicating a total number of straight lines is greater.

Similarly, the priority order determination section 156, in each small area, acquires the number of straight lines in an image and then computes a value indicating a total number of straight lines for each of image data, as to image data having the geo tag data including the latitude and the longitude that belong to the small area.

Next, the priority order determination section 156 performs the prioritization of image data so as to set the higher priority order to the image data having the geo tag data including the latitude and the longitude that belong to each small area, as a value indicating a total number of straight lines is greater.

The priority order determination section 156, may also acquire the number of straight lines and the number of curves in each large area or in each small area, and then compute a rate of the number of straight lines relative to a total number of lines. In this case, the priority order determination section 156 performs the prioritization so as to set the higher priority order to the image data, as the computed rate is higher.

### (Sixth Processing Operation)

The priority order determination section 156 determines a latitude and a longitude of geo tag data belongs to which of a large area and a small area, based on a latitude and a longitude of the geo tag data extracted from each of image data, a set of a latitude and a longitude of an outer edge in the large area, and a set of a latitude and a longitude of an outer edge in the small area.

Next, the priority order determination section 156 performs the prioritization, based on altitude information of geo tag data, as to image data in each large area.

Subsequently, the priority order determination section 156 performs the prioritization, based on altitude information of geo tag data, as to image data in each small area.

The priority order determination section 156 may perform the prioritization according to the number of floors, in a case where the altitude information of the geo tag data indicates the number of floors of building.

### (Seventh Processing Operation)

The priority order determination section 156 determines a latitude and a longitude of geo tag data belongs to which of a large area and a small area, based on a latitude and a longitude of the geo tag data extracted from each of image data, a set of a latitude and a longitude of an outer edge in the large area, and a set of a latitude and a longitude of an outer edge in the small area.

Next, the priority order determination section 156, in each large area, counts the number of objects in an image and then sums the number of objects, as to the image data having the geo tag data including the latitude and the longitude that belong to the large area.

Next, the priority order determination section 156 performs the prioritization of the image data in each large area so as to set the higher priority order to the image data, as the total number of objects is greater.

Similarly, the priority order determination section 156, in each small area, counts the number of objects in an image and then sums the number of objects, as to image data having the geo tag data including the latitude and the longitude that belong to the small area.

Next, the priority order determination section 156 performs the prioritization of the image data in each small area so as to set the higher priority order, as the total number of objects is greater.

### (Eighth Processing Operation)

The priority order determination section 156 determines a latitude and a longitude of geo tag data belongs to which of a large area and a small area, based on a latitude and a longitude of the geo tag data extracted from each of image data, a set of a latitude and a longitude of an outer edge in the large area, and a set of a latitude and a longitude of an outer edge in the small area.

Next, the priority order determination section 156, in each large area, counts the number of objects with a predetermined facial expression (for example, smiling faces) in an image and then sums the number of objects with the predetermined facial expression, as to the image data having the geo tag data including the latitude and the longitude that belong to the large area.

Next, the priority order determination section 156 performs the prioritization of the image data so as to set the higher priority order to the image data, as the total number of objects with the predetermined facial expression is greater.

Similarly, the priority order determination section 156, in each small area, counts the number of objects with a predetermined facial expression (for example, smiling faces) in an image and then sums the number of objects with the predetermined facial expression, as to image data having the geo tag data including the latitude and the longitude that belong to the small area.

Next, the priority order determination section 156 performs the prioritization of the image data so as to set the higher priority order, as the total number of objects with the predetermined facial expression is greater.

The priority order determination section 156 may compute a rate of the number of objects with the predetermined facial expression relative to a total number of objects, as to the image data having the geo tag data including the latitude and the longitude that belong to each large area or in each small area. In this case, the priority order determination section 156 performs prioritization so as to set the higher priority order, as the computed rate is higher.

In accordance with the first to eighth processing operations describe above, a priority order is assigned to each of image data in a unit of a large area, or alternatively, a priority order is assigned thereto in a unit of a small area. Items of priority order information are associated with geographic area information of the corresponding large area or small area and information indicative of a time when prioritization is performed, and then, the associated information is stored in the storage unit 120.

The display processing section 158 causes the display 130 to display an image indicative of a priority order of image data in a unit of a large area and an image indicating prioritization of image data in a unit of a small area, based on priority order information, geographic area information, and information indicative of a time when rendering is performed, each of which is stored in the storage unit 120.

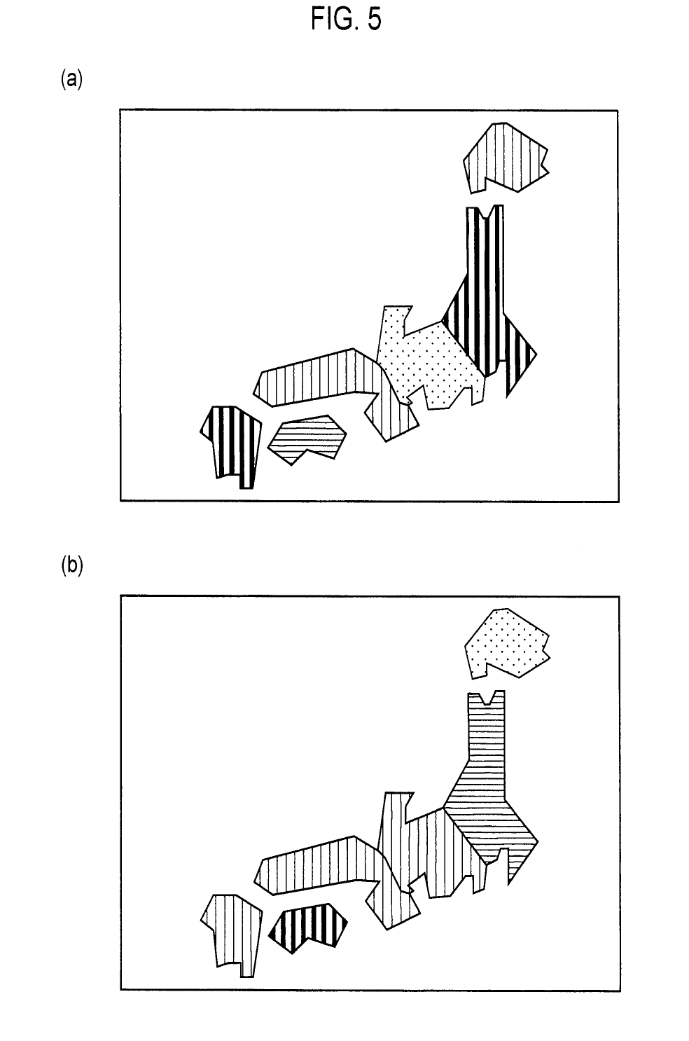

FIG. 4 is a view showing one example of a map image indicative of prioritization of image data. Referring to FIG. 4 (a), a priority order of image data in a unit of a large area can be recognized by means of color. On the other hand, referring to FIG. 4 (b), a priority order of image data in a unit of each small area can be recognized by means of color. A user operates an operation unit, although not shown, in the set top box 10, whereby if expansion or reduction of the map image is instructed, in response to the instruction the display processing section 158 appropriately changes a map image shown in FIG. 4 (a) and a map image shown in FIG. 4 (b) to each other and then causes the display 130 to display the changed map image.

FIG. 5 is a view showing one example of a map image indicative of the prioritization of the image data at different time. The display processing section 158 reads out from the storage unit 120 the priority order information associated with one area and the information indicative of time when the prioritization is performed. Further, when a user instructs the display at different time by operating an operation unit, although not shown, in the set top box 10, the display processing section 158 appropriately changes a map image shown in FIG. 5 (a) and a map image shown in FIG. 5 (b) to each other and then causes the display 130 to display the changed map image.

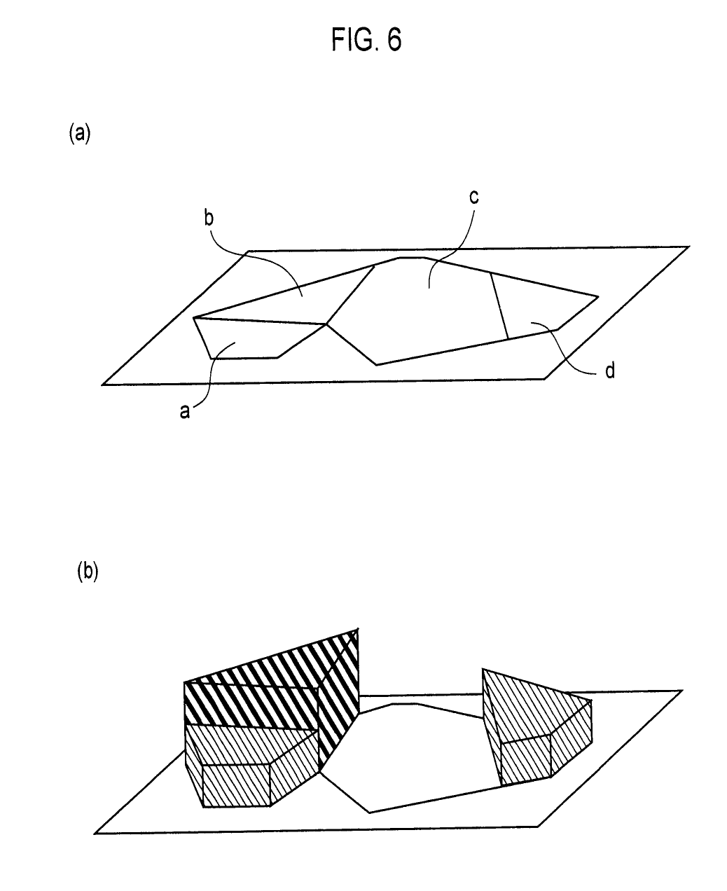

FIG. 6 is a view showing another example of a map image indicative of prioritization of image data. As shown in FIG. 6 (a), let us consider a case in which four small areas, i.e., a small area “a” to a small area “d” exist. The display processing section 158, as shown in FIG. 6 (b), refers to the number of image data that correspond to geo tag data including a latitude and a longitude that belong to a respective one of the small area “a” to the small area “d”, forms an image such that an elevation direction of a corresponding small area is longer as the number of the image data is larger, and causes the display 130 to display the image.

For example, in a case where prioritization has been performed in accordance with a rate of the number of objects, each of which has a smiling face in facial expression, relative to a total number of objects, the display processing section 158 may assign a predetermined mark image to an image corresponding to an area having high priority order on each of the map images of FIG. 4 to FIG. 6. In this case, a user can easily recognize a sightseeing place or the like.

### (2) Operation of Set Top Box

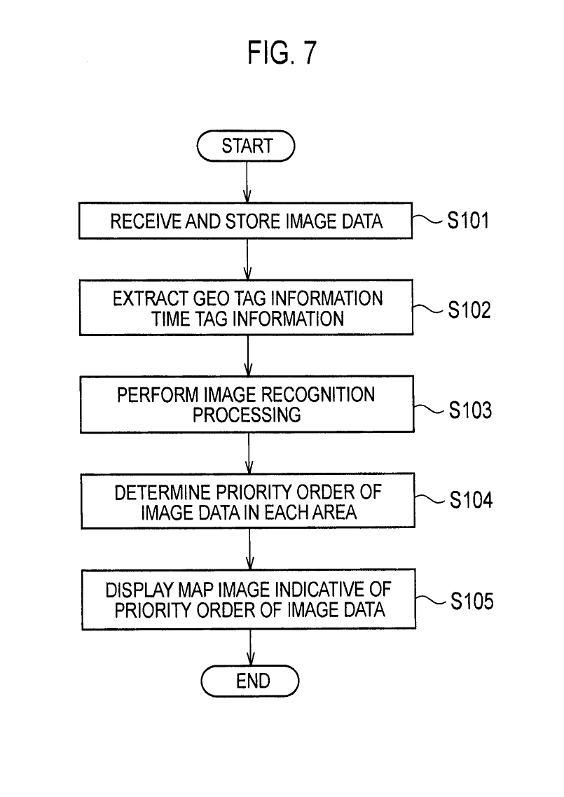

FIG. 7 is a flowchart showing an operation of the set top box 10.

In step S101, the set top box 10 receives and stores image data that is transmitted from a digital camera.

In step S102, the set top box 10 extracts geo tag data and time tag data that are included in the image data.

In step S103, the set top box 10 performs image recognition processing, based on the image data.

In step S104, the set top box 10 determines a priority order of image data in a unit of a large area and a priority order of image data in a unit of a small area.

In step S105, the set top box 10 displays a map image indicative of a priority order of image data.

### (3) Operations and Advantageous Effects

The set top box 10 extracts geo tag data included in image data, and based on the geo tag data, determines a priority order of image data in a unit of a large area and a priority order of image data in a unit of a small area. Further the set top box 10 displays a map image indicative of a priority order of image data in a unit of a large area and a map image indicative of a priority order of image data in a unit of a small area. In a case where a degree of importance of image data is associated with a position, appropriate prioritization can be performed as to image data by determining a priority order of image data, based on geo tag data.

In addition, the set top box 10 of the embodiment, in addition to the geo tag data, determines a priority order of image data by utilizing time tag data, the number of types of user IDs, and an image recognition result as well. In this manner, appropriate prioritization utilizing a variety of elements other than a position element can be performed.

### (4) Other Embodiments

As described above, while the present disclosure was described by way of embodiment, it should not be understood that the discussion and drawings forming a part of this disclosure limits the invention. From this disclosure, a variety of substitutive embodiments, examples, and operational techniques would have been self-evident to one skilled in the art.

The foregoing embodiments described that the set top box 10 performs, in a standalone manner, extraction of geo tag data from image data, image recognition processing, prioritization of image data, and display of a map image indicative of a priority order. However, the processing operations may be shared and performed by a plurality of devices.

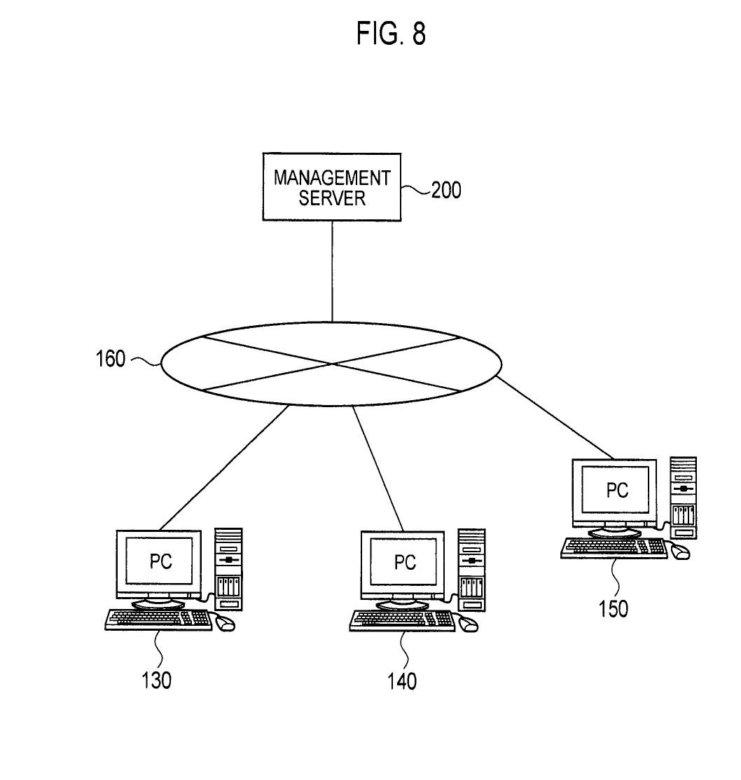

FIG. 8 is an entire schematic structural view of a content management system. The content management system shown in FIG. 8 includes: a management server 200; a personal computer (PC) 130, a PC 140, and a PC 150; and a communication network 160 for connecting the management server 200 and the PC 130 to the PC 150 to each other.

In the content management system, the management server 200 and the PC 130 to the PC 150 share and perform the processing operations of the image data storage processing section 152, the tag data extraction section 154, the priority order determination section 156, and the display processing section 158 in the control unit 110 of the set top box 10 shown in FIG. 1.

Specifically, a control unit of each of the PC 130 to the PC 150 includes the image data storage processing section 152, the tag data extraction section 154, and the display processing section 158, and a control unit of the management server 200 includes the priority order determination section 156.

In this case, the image data storage processing section 152 in the control unit of each of the PC 130 to the PC 150 receives image data and then causes a storage unit in the PC 130 to the PC 150 to store the received image data.

The tag extraction section 154 in the control unit of each of the PC 130 to the PC 150 extracts geo tag data from the image data that is stored in the storage unit. Further the tag extraction section 154 in the control unit of each of the PC 130 to the PC 150 transmits the extracted geo tag data to the management server 200 via the communication network 160.

Upon receipt of the transmitted geo tag data, the priority order determination section 156 in the control unit of the management server 200 performs the prioritization of image data in a unit of a large area and the prioritization of image data in a unit of a small area, based on the received geo tag data. Further the determination section 156 in the control unit of the management server 200 transmits priority order information, geographic area information, and information indicative of a time when prioritization is performed, to the PC 130 to the PC 150 via the communication network 160.

The display processing section 158 in the control unit each of the PC 130 to the PC 150 displays a map image indicative of a priority order of image data in a unit of a large area and a map image indicative of image data in a unit of a small area, based on priority order information, geographic area information, and information indicative of a time when prioritization is performed.

While the foregoing embodiments described a case in which image data is employed a content data, the present disclosure can be applied similarly in a case where another item of content data such as voice data or document data is employed as well.

Although not described in the above embodiments, a computer programs may be provided which causes a computer to perform the steps shown in FIG. 7. Further, such computer program may be included in a computer readable medium. The computer programs may be installed in the computer by using the computer readable medium. The computer readable medium having the computer programs stored therein may be a non-volatile recording medium. The non-volatile recording medium is not any specified recording medium, but may be a recording medium such as CD-ROM or DVD-ROM, for example.

It is therefore to be understood that the present disclosure includes various embodiments which are not mentioned herein. Accordingly, the present disclosure should be limited only by the claims described later.

What is claimed is:

1. A tag data management apparatus for managing tag data indicative of an attribute of content data, comprising:
an extraction section that extracts positional information included in the content data, the positional information being indicative of a position associated with the content data; and
a priority order determination section that determines a priority order of the content data, based on the positional information extracted by the extraction section.

2. The tag data management apparatus according to claim 1, wherein the priority order determination section determines the priority order based on each of a plurality of predetermined geographic areas.

3. The tag data management apparatus according to claim 2, wherein
the extraction section extracts time information attached to the content data, the time information being indicative of a time associated with the content data, and
the priority order determination section determines a priority order of the content data, based on the time information extracted by the extraction section.

4. The tag data management apparatus according to claim 2, wherein the priority order determination section determines the priority order of the content data in accordance with at least either one of: the number of content data having a position included in the predetermined geographic area; and the number of persons who generate the content data having a position included in the predetermined geographic area.

5. The tag data management apparatus according to claim 2, wherein
the content data is image data, and
the priority order determination section determines the priority order of the content data, in accordance with a result of image recognition using the image data.

6. The tag data management apparatus according to claim 5, wherein a result of the image recognition is at least either one of the number of objects and a facial expression of the objects.

7. The tag data management apparatus according to claim 2, comprising:
a first display processing section that displays an image indicative of the priority order of the content data having the positional information, for each of the plurality of the predetermined geographic areas.

8. The tag data management apparatus according to claim 2, comprising:
a second display processing section that displays an image indicative the priority order of the content data having the positional information at different time, for each of the plurality of the predetermined geographic areas.

9. A tag data management system for managing tag data indicative of an attribute of content data, comprising:
an extraction section that extracts positional information included in the content data, the positional information being indicative of a position associated with the content data; and
a priority order determination section that determines a priority order of the content data, based on the positional information extracted by the extraction section.

10. A non-transitory computer readable medium including a computer program cause a computer to manage tag data indicative of an attribute of content data, the computer program cause the computer to perform a method comprising the steps of:
extracting positional information included in the content data, the positional information being indicative of a position associated with the content data; and
determining a priority order of the content data, based on the extracted positional information.

11. A tag data management method used in a tag data management system for managing tag data indicative of an attribute of content data, comprising the steps of:
extracting positional information included in the content data, the positional information being indicative of a position associated with the content data; and
determining a priority order of the content data, based on the extracted positional information.
